(19) United States
(12) Patent Application Publication
(10) Pub. No.: US 2021/0158478 A1
(43) Pub. Date: May 27, 2021

(54) IMAGE RESIZING THROUGH AN IMAGE OPTIMIZER

(71) Applicant: International Business Machines Corporation, Armonk, NY (US)

(72) Inventors: Lei Bao, Wuxi (CN); Liang Rong, Suzhou (CN); Hai Qun Tang, Shanghai (CN); Ketan Priyakant Pancholi, Austin, TX (US); Ying Tang, Shanghai (CN)

(21) Appl. No.: 16/691,582

(22) Filed: Nov. 21, 2019

(51) Int. Cl. G06T 3/40; G09G 5/00

(52) U.S. Cl. CPC G06T 3/40; G09G 5/005; G06F 17/212; G09G 2350/00; G09G 2340/145

(57) ABSTRACT

Embodiments of the present disclosure relate to a method, system, and computer program product for resizing an image. An image on a server is identified by a user through a terminal device, where the image has a first size. A image optimizer is positioned between the terminal device and the server. A image optimizer determines the display dimensions of the terminal device also determines that the requested image may need to be resized to a second size. The image optimizer receives the image from the server, resizes the image to the second size, and transmits the image to the terminal device.

### BACKGROUND

The present disclosure generally relates to image processing, and more specifically, to a method, system, and computer program product for resizing an image.

Mobile devices are popular for accessing web-based applications and downloading content, including images, from Internet servers. There is a great number of different types and models of mobile devices, and the sizes of the associated displays will vary significantly. The sizes of the images stored on the servers will vary significantly as well. Many of the images stored on the servers are stored with larger sizes to accommodate the widest variety of mobile device screens. Therefore, the time and bandwidth associated with image downloads to mobile devices will vary significantly as well.

### SUMMARY

A method, system, and computer program product are provided for resizing an image.

According to one embodiment of the present disclosure, there is provided a computer-implemented method. The method includes identifying, by a terminal device, an image resident on a server to be provided to the terminal device. The image has a first size. The method also includes determining, by an image optimizer, a second size of the image to be displayed at the terminal device. The second size is different from the first size. The method further includes, in response to a value of the first size exceeding a value of the second size, resizing, by the image optimizer, the image from the first size to the second size. The second size of the image is configured to conform to display dimensions of the terminal device. The method also includes providing the image having the second size to the terminal device.

According to another embodiment of the present disclosure, there is provided a computer system. The system includes a server and a terminal device communicatively coupled to the server. The terminal device is configured to identify an image resident on the server to be provided to the terminal device, the image having a first size. The system also includes an image optimizer communicatively coupled to the terminal device and the server. The image optimizer is configured to determine a second size of the image to be displayed at the terminal device. The second size is different from the first size. The image optimizer is also configured to, in response to a value of the first size exceeding a value of the second size, resize the image from the first size to the second size. The second size of the image is configured to conform to display dimensions of the terminal device. The image optimizer is further configured to provide the image having the second size to the terminal device.

According to yet another embodiment of the present disclosure, there is provided a computer program product for resizing an image. The computer program product includes one or more computer-readable storage media and program instructions collectively stored on the one or more computer-readable storage media. The program instructions include program instructions to obtain an image to be provided to a terminal device, the image being of a first size. The program instructions also include program instructions to determine a second size of the image which is to be displayed at the terminal device. The program instructions further include, in response to the first size exceeding the second size, program instructions to resize the image from the first size to the second size and to provide the image of the second size to the terminal device.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4 depicts an example environment in which embodiments of the present disclosure can be implemented.

FIG. 5 depicts an interaction diagram for supplying a terminal device with an image of an appropriate size according to embodiments of the present disclosure.

FIG. 6 depicts a flowchart of an example method for resizing an image according to embodiments of the present disclosure.

Throughout the drawings, same or similar reference numerals represent the same or similar elements.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

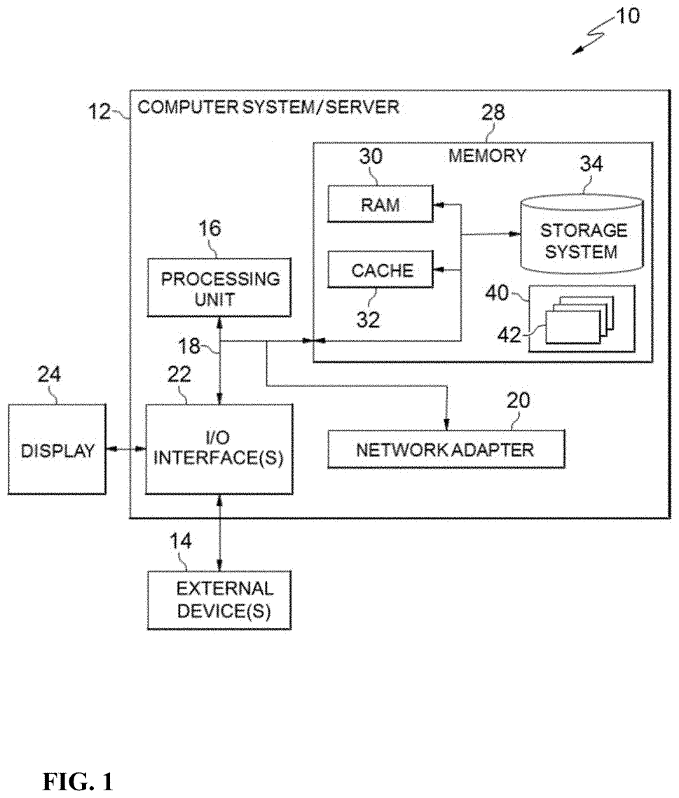

Referring now to FIG. 1, a schematic of an example of a cloud computing node is shown. Cloud computing node 10 is only one example of a suitable cloud computing node and is not intended to suggest any limitation as to the scope of use or functionality of the embodiments described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to the processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

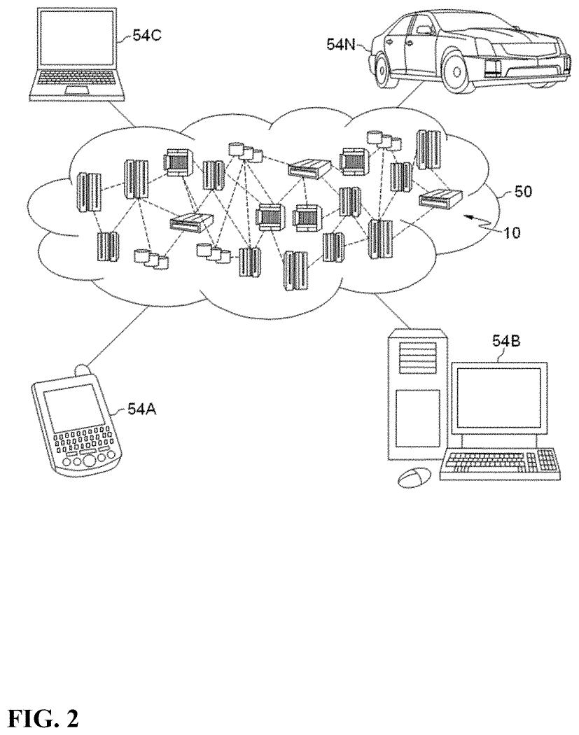

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

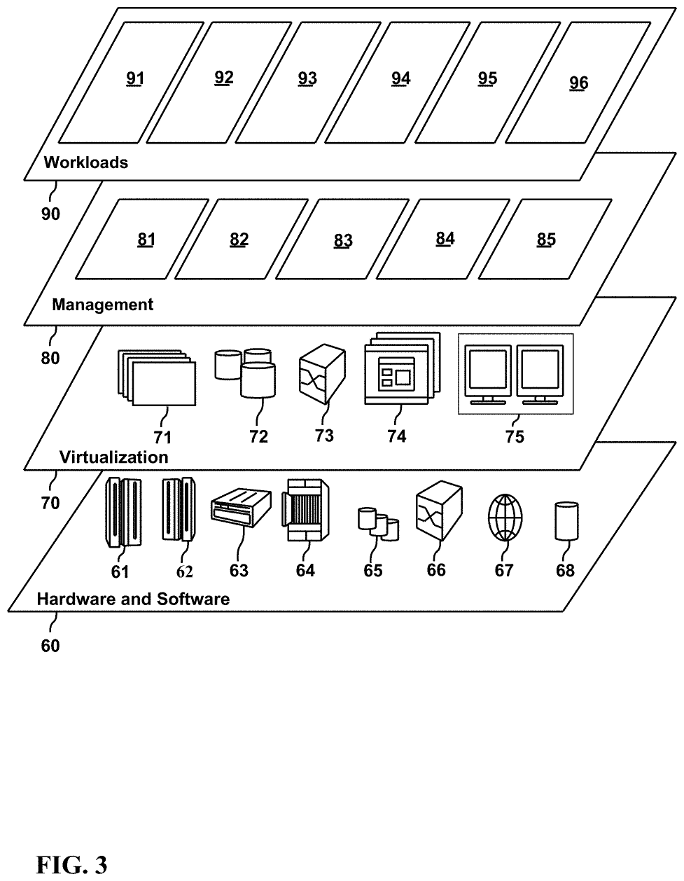

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

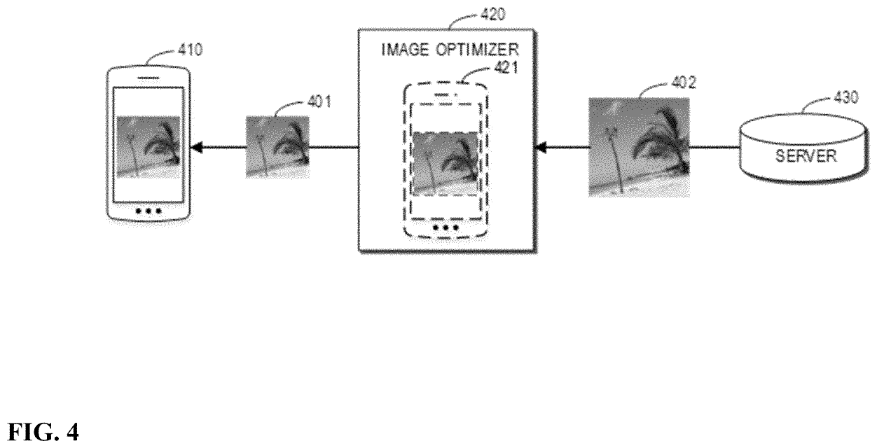

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and image resizing 96. Hereinafter, reference will be made to FIG. 4 to FIG. 6 to describe details of the image resizing 96.

As described above, different terminal devices may have different screen sizes. However, different terminal devices may retrieve a same image from a same server. In order to adapt different screen sizes, the image may be scaled into different sizes at the server in advance and a script running at a terminal device may download the image of a desired size from the server. However, since both the server and the script do not know a final display size of the image which is to be displayed at the terminal device, the size of the downloaded image may be not exactly the same as the final display size. Therefore, network bandwidth, CPU resources, and power consumption for downloading the image of an inappropriate size are wasted. More importantly, user experience will be adversely affected.

In order to at least partially solve the above and other potential problems, embodiments of the present disclosure provide a new solution for resizing an image. According to embodiments of the present disclosure, an image to be provided to a terminal device is obtained, which is of a first size. A second size of the image which is to be displayed at the terminal device is determined. In response to a value of the first size exceeding a value of the second size, the image is resized from the first size to the second size. Then, the image of the second size is provided to the terminal device. In this way, the terminal device can get the image of a size that is exactly the same as its final display size, without wasting network bandwidth, CPU resources, and power consumption for downloading an image of an inappropriate size. Moreover, the terminal device does not need to perform a further operation (such as, zooming in or zooming out) on the image, thereby improving the user experience significantly.

With reference now to FIG. 4, an environment 400 in which embodiments of the present disclosure can be implemented is shown. In FIG. 4, the environment 400 is shown to include a terminal device 410, an image optimizer 420 and a server 430. It is to be understood that the structure and/or functionality of the environment 400 are described only for the purpose of illustration without suggesting any limitations as to the scope of the present disclosure. The embodiments of the present disclosure can be embodied with a different structure and/or functionality.

As used herein, the term “terminal device” refers to any device having wireless or wired communication capabilities. Examples of the terminal device 410 may include, but not limited to, a user equipment (UE), a mobile phone, a cellular phone, a smart phone, a personal digital assistant (PDA), a portable computer, an image capture device such as a digital camera, a gaming device, a music storage and playback appliance, or an Internet appliance enabling wireless or wired Internet access and browsing and the like.

In some embodiments, the server 430 is a web server, which is configured to store webpages and contents (such as, images, videos, audios and the like) contained in the webpages. The server 430 provides a webpage and/or contents contained therein to any device in response to receiving one or more requests from the device. In the following, only for the purpose of illustration, the web server will be taken as an example of the server 430. It is to be understood that the scope of the present disclosure is not limited in this aspect. In other embodiments, the server 430 can be any storage device for storing images to be retrieved.

In some embodiments, the image optimizer 420 may be integrated into the terminal device 410 or the server 430. In one embodiment, for example, the image optimizer 420 communicate with the terminal device 410 and the server 430 directly or via a network (not shown), such as the Internet. Alternatively, in other embodiments, the image optimizer 420 is implemented at a device which is separate from the terminal device 410 and the server 430. For example, in some embodiments, the image optimizer 420 is integrated into a Content Delivery Network (CDN) edge server, which is used for accelerating accesses to a website, distributing content from web servers to terminal devices, enabling a terminal device to get desired content nearby, and/or improving the response speed and success rate for a terminal device accessing a website. In some embodiments, the image optimizer 420 may be implemented by the computer system/server 12 as discussed with reference to FIG. 1.

In some embodiments, the terminal device 410 requests, from the server 430, a webpage for display. The webpage may include an image 402. In order to display the webpage including the image 402, the terminal device 410 further requests the image 402 from the server 430. For example, an original length or width of the image 402 may exceed that of a viewport for displaying the webpage at the terminal device 410. As used herein, the term “viewport” refers to a region on the screen of the terminal device for displaying a webpage. For example, the size of the viewport can be the same as or below the screen size.

In some embodiments, the requests for the webpage as well as the image 402 are intercepted by the image optimizer 420. As such, the webpage (for example, a Hyper Text Markup Language (HTML) file corresponding to the webpage) and the image 402 are transmitted from the server 430 to the image optimizer 420. In some embodiments, the image optimizer 420 obtains information about the size of the viewport from the terminal device 410, and creates a virtual viewport 421 of the same size based on the obtained information, thereby simulating the viewport of the terminal device 410 in the virtual viewport 412. The image optimizer 420 renders the webpage including the image in the virtual viewport 421. For example, the image optimizer 420 renders the webpage by parsing the HTML file corresponding to the webpage through one or more application programming interfaces (APIs) and converting the HTML file into displayable contents in the virtual viewport 421. After rendering the webpage including the image in the virtual viewport 421, the image optimizer 420 determines the rendered size of the image, which will be the same as a final display size of the image 402 which is to be displayed at the terminal device 410. If the original size of the image 402 exceeds the rendered size, the image optimizer 420 resizes the image 402 from the original size to the rendered size, so as to derive a resized image 401. Then, the image optimizer 420 provides the resized image 401 to the terminal device 410.

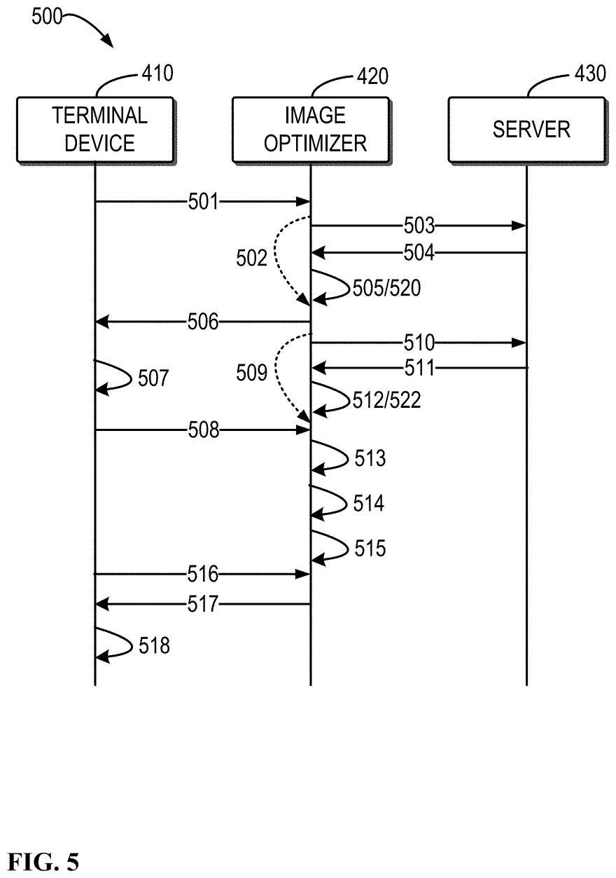

FIG. 5 depicts an interaction diagram for supplying the terminal device 410 with an image of an appropriate size according to embodiments of the present disclosure. FIG. 5 involves the terminal device 410, the image optimizer 420 and the server 430 as shown in FIG. 4.

As shown in FIG. 5, the terminal device 410 transmits 501 a request for a webpage, which includes an image (such as, the image 402). This request for a webpage is based on the terminal device 410 identifying the webpage containing the image 402 to download through user interaction. The request for the webpage is intercepted by the image optimizer 420. In response to receiving the request for the webpage, the image optimizer 420 retrieves the webpage without the image 402) from a location storing the webpage (discussed further herein with respect to operation 504), e.g., in one embodiment, the server 430.

In some embodiments, if the webpage has been stored in a cache (not shown) coupled with the image optimizer 420, the image optimizer 420 retrieves 502 the webpage (such as a HTML file corresponding to the webpage) from the cache directly. The cache retrieval operation 502 is shown in phantom to indicate the operation 502 is limited to the image optimizer 420 and the associated cache. Alternatively, if the webpage has not been stored in the cache, the image optimizer 420 forwards 503 the request for the webpage to the server 430 (such as, for example, a web server storing the webpage) and retrieves 504 the webpage (such as, the HTML file corresponding to the webpage) from the server 430.

In some embodiments, the requested webpage has a condition where a cookie is resident within the request for the webpage from the terminal device 410. This terminal device identification cookie includes identification information that identifies the terminal device 410, including the dimensions of the viewport of the terminal device 410. The presence of such a terminal device identification cookie is indicative that the terminal device and the image optimizer 420 have communicated previously. In at least some other embodiments, the request for the webpage from the terminal device 410 does not include a terminal device identification cookie. The lack of such a cookie is indicative that this is the first time this terminal device 410 has communicated with this image optimizer 420. The dimensions of the viewport of the terminal device 410 must be known by the image optimizer 420 to properly resize the downloaded image 402. Therefore, the image optimizer 420 will obtain this information from the terminal device 410 as described further.

For those embodiments where the requested webpage has a condition where the terminal device identification cookie is not embedded in the request for the webpage, in response to retrieving 504 the webpage, the image optimizer 420 creates a script for obtaining information from the terminal device 410, and incorporates 505 the script into the HTML file corresponding to the webpage. For example, the script, when executed at the terminal device 410, obtains information about a size of the viewport for displaying the webpage at the terminal device 410 and generates a cookie including the information. Alternatively, or in addition, in some embodiments, the image optimizer 420 may further store 520 the webpage incorporated with the script into the cache for subsequent quick retrieval.

The image optimizer 420 transmits 506 the webpage (without the image 402) incorporated with the script to the terminal device 410 as a response to the request for the webpage. In response to receiving the webpage transmitted 506 from the image optimizer 420 and detecting the script in the webpage, the terminal device 410 executes 507 the script to obtain the information about the size of the viewport and generate the cookie including the information. The terminal device 410 transmits 508 the cookie including the information to the image optimizer 420.

After the webpage is sent to the terminal device 410, the image optimizer 420 retrieves contents in the webpage before receiving further requests for these contents from the terminal device 410, so as to shorten the time for loading the webpage. In some embodiments, in response to the webpage including the image (such as the image 402), the image optimizer 420 retrieves the image 402 from a location storing the image.

In some embodiments, if the image 402 has been stored in the cache coupled with the image optimizer 420, the image optimizer 420 retrieves 509 the image from the cache directly. The cache retrieval operation 509 is shown in phantom to indicate the operation 509 is limited to the image optimizer 420 and the associated cache. Alternatively, if the image has not been stored in the cache, the image optimizer 420 transmits 510 a request for the image 402 to the server 430 (such as, the web server storing the contents of the webpage) and retrieves 511 the image 402 from the server 430. In some embodiments, the image optimizer 420 may further store 522 the image into the cache coupled with the image optimizer 420 for subsequent quick retrieval. It is assumed that the retrieved image is of a first size (such as, 1000 pixel*1000 pixel).

For those embodiments where the viewport size information was retrieved through a script-requested cookie, in response to obtaining the information about the size (such as, for example, 1334 pixel*750 pixel) of the viewport transmitted 508 from the terminal device 410, the image optimizer 420 creates 513 a virtual viewport of the same size and renders 514 the webpage including the image 401 in the virtual viewport. For example, the image optimizer 420 renders the webpage by parsing the HTML file corresponding to the webpage and converting the HTML file into displayable contents in the virtual viewport 421. It is to be understood that any suitable algorithm currently known or to be developed in the future can be utilized by the image optimizer 420 for rendering the webpage, such as, an algorithm for implementing a web browser. After rendering the webpage including the image 401 in the virtual viewport 421, the image optimizer 420 may determine a size of the rendered image 401 as a second size (such as, 750 pixel*750 pixel).

In some embodiments, in response to a value of the first size exceeding a value of the second size, the image optimizer 420 may resize 515 the image 402 from the first size to the second size. Alternatively, in response to the first size being the same as or below the second size, the resizing 515 can be omitted. For example, the first size may be characterized by a first length (such as, 1000 pixels) and a first width (for example, 1000 pixels), and the second size may be characterized by a second length (such as, 750 pixels) and a second width (such as, 750 pixel). In some embodiments, in response to the first length exceeding the second length and/or the first width exceeding the second width, the image optimizer 420 may resize 515 the image 402 from the first size to the second size. Alternatively, in response to the first length being the same as or below the second length and the first width being the same as or below the second width, the resizing 515 can be omitted. Additionally, in some embodiments, in response to the image 402 being resized, the image optimizer 420 may store the resized image 401 into the cache for subsequently quick retrieval.

In some embodiments, the image optimizer 420 may maintain a list of terminal devices, which are associated with different sizes of viewports. The image optimizer 420 may maintain a corresponding virtual viewport for each of the terminal devices in the list. In some embodiments, in response to obtaining the information about the size of the viewport transmitted 508 from the terminal device 410, the image optimizer 420 may firstly check if the size of the viewport of the terminal device 410 matches that of any terminal device in the list. If a match is found, it means that a virtual viewport of the same size has been created and thus the action 513 can be omitted. If no match is found, the image optimizer 420 may create 513 a virtual viewport for the terminal device 410 and add the terminal device 410 to the list.

For those embodiments where the viewport size information was embedded in the original webpage request from the terminal device 410, in response to receiving the webpage (without the image) transmitted 506 from the image optimizer 420 and determining that the webpage is missing the image 402, the terminal device 410 transmits 516 a request for the image 402. The request for the image 402 is intercepted by the image optimizer 420. In response to receiving the request for the image 402, the image optimizer 420 transmits 517 the image 401 of an appropriate size (such as the second size) to the terminal device 410. In response to receiving the image 401, the terminal device 410 renders 518 the webpage as well as the image 401 in the local viewport on the terminal device 410. For example, the terminal device 410 may render the webpage by parsing the HTML file corresponding to the webpage and converting the HTML file into displayable contents in the local viewport. Since the size of the image 401 has been adjusted according to its final display size, the image 401 can be displayed at the terminal device 410 without any further processing.

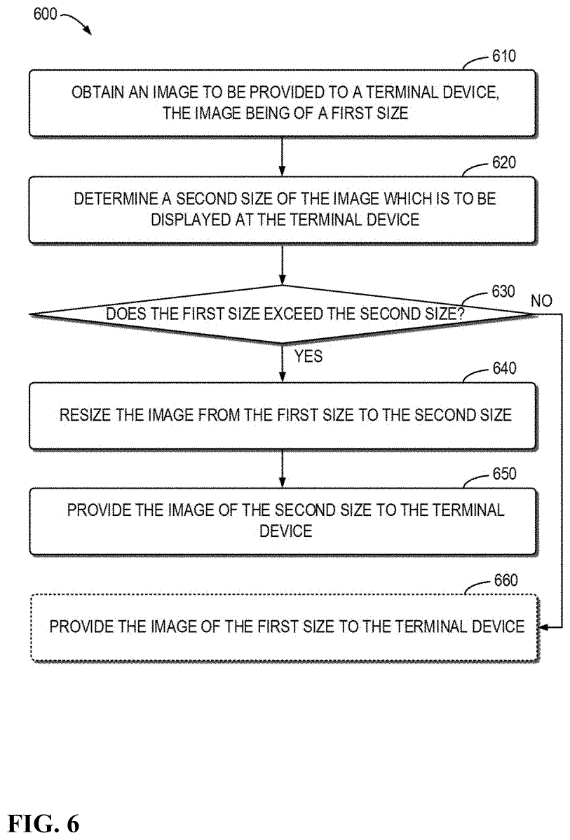

FIG. 6 depicts a flowchart of an example method 600 for resizing an image according to embodiments of the present disclosure. For example, the method 600 is implemented by the image optimizer 420 as shown in FIGS. 4-5. It is to be understood that the method 600 may also comprise additional operation blocks (not shown) and/or may omit the illustrated operation blocks. The scope of the present disclosure described herein is not limited in this aspect.

At operation block 610, the image optimizer 420 obtains an image (such as, the image 402) to be provided to a terminal device (such as, the terminal device 410). The image 402 has a first size.

In some embodiment, in response to receiving a request for a webpage including the image 402 from the terminal device 410, the image optimizer 420 obtains the webpage from a location (such as, the server 430 or the cache coupled with the image optimizer 420) storing the webpage. The image optimizer 420 may further obtain the image from a location (such as, the server 430 or the cache) storing the image.

At operation block 620, the image optimizer 420 determines a second size of the image 402 which is to be displayed at the terminal device 410.

In some embodiments, in order to determine the second size, the image optimizer 420 obtains, from the terminal device 410, information which indicates a size of a viewport for displaying the webpage at the terminal device 410. In response to obtaining the information indicating the size of the viewport, the image optimizer 420 creates a virtual viewport of the same size, and then renders the webpage including the image 402 in the virtual viewport. The image optimizer 420 may then determine a size of the rendered image 401 as the second size.

In some embodiments, in order to obtain the information, the image optimizer 420 creates a script for obtaining the information and incorporates the script for obtaining the information into the webpage. The image optimizer 420 transmits the webpage including the script to the terminal device 410 as a response to the request for the webpage including the image. In response to the webpage including the script being transmitted to the terminal device 410, the image optimizer 420 may receive the information from the terminal device 410, where the information is generated by executing the script at the terminal device 410.

At operation block 630, the image optimizer 420 determines if the first size of the image 402 exceeds the second size. In response to the first size exceeding the second size, at operation block 640, the image optimizer 420 resizes the image 402 from the first size to the second size.

In some embodiments, the first size is characterized by a first length and a first width, and the second size is characterized by a second length and a second width. In some embodiments, in response to the first length exceeding the second length and/or the first width exceeding the second width, the image optimizer 420 may resize the image 402 from the first size to the second size.

At operation block 650, the image optimizer 420 provides the image of the second size (such as, the image 401) to the terminal device 410.

In some embodiments, providing the image 401 of the second size to the terminal device 410 may be responsive to a request for the image 402 from the terminal device 410.

Alternatively, or in addition, in some embodiments, if the image optimizer 420 determines that the first size is the same as or below the second size at operation block 630, at operation block 660, the image optimizer 420 provides the image 402 of the first size to the terminal device.

It can be seen that, according to embodiments of the present disclosure, an image to be provided to a terminal device can be obtained, which is of a first size. A second size of the image which is to be displayed at the terminal device can be determined. In response to the first size exceeding the second size, the image is resized from the first size to the second size. Then, the image of the second size is provided to the terminal device. In this way, the terminal device can get the image of a size that is exactly the same as its final display size, without wasting network bandwidth, CPU resources, and power consumption for downloading an image of an inappropriate size. Moreover, the terminal device does not need to perform a further operation (such as, zooming in or zooming out) on the image, thereby improving the user experience significantly.

It should be noted that the image resizing operation 640 according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying, by a terminal device, an image resident on a server to be provided to the terminal device, the image having a first size;
determining, by an image optimizer, a second size of the image to be displayed at the terminal device, the second size different from the first size; and
in response to a value of the first size exceeding a value of the second size:
resizing, by the image optimizer, the image from the first size to the second size, wherein the second size of the image is configured to conform to display dimensions of the terminal device; and
providing the image having the second size to the terminal device.

2. The method of claim 1, wherein determining the second size of the image comprises:
simulating, by the image optimizer, the display dimensions of the terminal device.

3. The method of claim 2, wherein determining the second size of the image further comprises:
obtaining, by the image optimizer, information from the terminal device, the information indicating the display dimensions of a viewport of the terminal device for displaying the image at the terminal device;
creating, by the image optimizer, a virtual viewport representative of the viewport of the terminal device; and
rendering, by the image optimizer, the image in the virtual viewport.

4. The method of claim 3, wherein obtaining the information from the terminal device comprises:
transmitting, to the server, through the image optimizer, a request for the image from the terminal device; and
determining, by the image optimizer, a condition selected from the group of conditions consisting of:
a terminal device identification cookie resident within the request; and
a terminal device identification cookie not resident within the request.

5. The method of claim 4, wherein obtaining the information from the terminal device further comprises:
creating, by the image optimizer, responsive to a terminal device identification cookie not resident within the request, a script configured to obtain the information from the terminal device;
incorporating, by the image optimizer, the script into a webpage associated with the image transmitted by the server; and
transmitting, by the image optimizer, the webpage including the script to the terminal device as a response to the request.

6. The method of claim 4, wherein obtaining the information further comprises:
receiving, by the image optimizer, responsive to the terminal device identification cookie resident within the request, the terminal device identification cookie; and
identifying, by the image optimizer, the terminal device subject to the terminal device identification cookie.

7. The method of claim 1, further comprising:
providing, in response to the value of the first size below the value of the second size, by the image optimizer, the image having the first size to the terminal device.

8. A computer system comprising:
a server;
a terminal device communicatively coupled to the server, the terminal device configured to identify an image resident on the server to be provided to the terminal device, the image having a first size; and
an image optimizer communicatively coupled to the terminal device and the server, the image optimizer configured to:
determine a second size of the image to be displayed at the terminal device, the second size different from the first size; and
in response to a value of the first size exceeding a value of the second size:
resize the image from the first size to the second size, wherein the second size of the image is configured to conform to display dimensions of the terminal device; and
provide the image having the second size to the terminal device.

9. The system of claim 8, the image optimizer further configured to:
simulate the display dimensions of the terminal device.

10. The system of claim 9, the image optimizer further configured to:
obtain information from the terminal device, the information indicating the display dimensions of a viewport of the terminal device for displaying the image at the terminal device;
create a virtual viewport representative of the viewport of the terminal device; and
render, the image in the virtual viewport.

11. The system of claim 10, the image optimizer further configured to:
transmit, to the server, through the image optimizer, a request for the image from the terminal device; and
determine a condition selected from the group of conditions consisting of:
a terminal device identification cookie resident within the request; and
a terminal device identification cookie not resident within the request.

12. The system of claim 11, the image optimizer further configured to:
create, responsive to the terminal device identification cookie not resident within the request, a script configured to obtain the information from the terminal device;
incorporate the script into a webpage associated with the image transmitted by the server; and
transmit the webpage including the script to the terminal device as a response to the request.

13. The system of claim 11, the image optimizer further configured to:
receive, responsive to the terminal device identification cookie resident within the request, the terminal device identification cookie; and
identify the terminal device subject to the terminal device identification cookie.

14. The system of claim 8, the image optimizer further configured to:
provide, in response to the value of the first size below the value of the second size, the image having the first size to the terminal device.

15. A computer program product for resizing an image, the computer program product comprising:
one or more computer-readable storage media; and
program instructions collectively stored on the one or more computer-readable storage media, the program instructions comprising:
program instructions to identify an image to be provided to a terminal device from a server, the image having a first size;
program instructions to determine, by an image optimizer, a second size of the image to be displayed at the terminal device, the second size different from the first size; and
in response to a value of first size exceeding a value of the second size,
program instructions to resize, by the image optimizer, the image from the first size to the second size, wherein the second size of the image is configured to conform to display dimensions of the terminal device; and
program instructions to provide the image of the second size to the terminal device.

16. The computer program product of claim 15, further comprising program instructions to:
simulate, by the image optimizer, the display dimensions of the terminal device.

17. The computer program product of claim 16, further comprising program instructions to:
obtain, by the image optimizer, information from the terminal device, the information indicating the display dimensions of a viewport of the terminal device for displaying the image at the terminal device;
create by the image optimizer, a virtual viewport representative of the viewport of the terminal device; and
render, by the image optimizer, the image in the virtual viewport.

18. The computer program product of claim 17, further comprising program instructions to:
transmit, to the server, through the image optimizer, a request for the image from the terminal device; and
determine a condition selected from the group of conditions consisting of:
a terminal device identification cookie resident within the request; and
a terminal device identification cookie not resident within the request.

19. The computer program product of claim 18, further comprising program instructions to:
create, by the image optimizer, responsive to the terminal device identification cookie not resident within the request, a script configured to obtain the information from the terminal device;
incorporate, by the image optimizer, the script into a webpage associated with the image transmitted by the server; and
transmit, by the image optimizer, the image including the script to the terminal device as a response to the request.

20. The computer program product of claim 18, the image optimizer further configured to:
receive, by the image optimizer, responsive to the terminal device identification cookie resident within the request, the terminal device identification cookie; and
identify, by the image optimizer, the terminal device subject to the terminal device identification cookie.
